(19) United States
(12) Patent Application Publication
(10) Pub. No.: US 2009/0206147 A1
(43) Pub. Date: Aug. 20, 2009

(54) METHOD OF PRODUCING ELECTRICAL CONNECTIONS FOR AN ELECTRICAL ENERGY STORAGE UNIT

(76) Inventors: Olivier Caumont, Quimper (FR); Pascal Paillard, Ligne (FR); Guy Saindrenan, Nantes (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/305,583

(22) PCT Filed: Jun. 21, 2007
(86) PCT No.: PCT/FR2007/001035

§ 371 Date: Dec. 18, 2008

(30) Foreign Application Priority Data
Jun. 21, 2006 (FR) 0605554

(51) Int. Cl. B23K 31/02; H01R 43/16; H01M 2/30; B23K 20/00; B23K 20/10; B23K 13/01

(52) U.S. Cl. 228/194; 29/874; 429/178; 228/193; 228/110.1; 219/615

(57) ABSTRACT

The invention relates to a method of producing electrical connections for an electrical energy storage unit (10), said unit employing at least one electrical energy storage element (70) placed inside a casing (20′), said casing having at least one cover (30, 40) containing the electrical energy storage element (70) in a main body (20) of the casing, said element (70) and said cover (30, 40) each having a current collector means, which method is characterized in that it includes at least one step of depositing gallium on one or other of the current collector means and a step of assembling two current collector means separated by the gallium coating followed by a diffusion brazing step carried out by the disposition and the pressing of a mass heated to a given temperature on the unit formed by two current collector means, the unit being brazed for a given time in order to produce the electrical connection for the electrical energy storage unit. The invention is particularly applicable for the production of electrical energy storage units such as super-capacitors, batteries or generators.

### DOMAIN OF THE INVENTION

The invention relates to the electrical energy storage units. It applies in particular, but not limiting, to supercondensers, condensers, and generators or batteries. More precisely, the present invention relates to processes for production of electrical connections of an electrical energy storage unit.

### PRESENTATION OF THE PRIOR ART

A substantial number of electrical energy storage units, known as high power, has recently been proposed, such as supercondensers, for example.

However, the known devices do not give total satisfaction as to their power connection.

In conventional terms, a supercondenser comprises a coil placed in a casing comprising a main body closed at its two ends by two covers which can be fitted with an electrical connecting stud. In the text hereinbelow, we will equally treat coil or energy storage coil element to designate the same piece.

To make an electrical connection of this electrical energy storage unit, an intermediate piece of electrical connection placed between the coil and each of the covers can be utilised.

Some other conceptions directly utilise the covers as pieces of electrical connection with the current collector formed by the current-collecting edges projecting over the coil at its two ends.

These current-collecting edges, or the intermediate electrical connection piece, are connected by means of a welding process, for example a transparency laser technique, to an external terminal such as the electrical connection studs, the covers themselves or any other current collector.

On the other hand and according to the technology selected, these designs likewise use, in general, external terminals or partly pressed intermediate pieces of electrical connection to form welding ranges having for example thinned zones such as or recesses preferably towards the interior of the main body of the casing.

The current-collecting edges of the coil are then connected electrically by welding at the level of the thinned zones.

Another example is the use of external terminals or intermediate pieces of electrical connection having internal flat faces and welding ranges in the form of external recesses. The text hereinbelow will discuss current-collecting pieces to equally designate external terminals or intermediate pieces of electrical connection.

This manufacturing process of electrical connections by welding an electrical energy storage unit whereof the current-collecting pieces are made of aluminium or light alloy can result in exposing the unit during the welding to high temperatures which risk thermally degrading the coils.

On the other hand, the fact that welding is necessarily limited to the worn welding zones limits the surface of zones effectively welded between the current-collecting pieces and the current-collecting edges of the coil. As a consequence, the current is not uniformly distributed in the coil due to the fact that all the current-collecting edges are not fully connected to the current-collecting piece.

This characteristic favours ionic and electronic concentrations in some turns of the coil to the detriment of others, thus resulting in an increase in the Rₛ resistance series of the electrical energy storage unit.

In addition, the majority of heat emitted in operating in the coil is evacuated axially in the extended current-collector then across the external current-collecting pieces via the welded zones or strongly in contact.

Thermal exchanges to the exterior, a substantial part of cooling the coil are then limited by restrained contact between the coil and the cover, which benefits reheating of the latter.

On the other hand, this manufacturing process of electrical connections of an energy storage unit is costly and complex.

In fact, the transparency laser welding technique is difficult to implement as it requires precise adjustment between the different pieces to be assembled, with poor adjustment resulting in the multiplication of holes across the current-collecting pieces which first engenders a loss of tightness of the current-collecting pieces and secondly poor energy yield from the electrical energy storage unit.

Also, use of the laser welding process is effective only with some nuances of aluminium or aluminium alloys such as the aluminium Serie 1000 (aluminium alloys comprising at least 99.9% aluminium) which are not ideally adapted to use in supercondensers. In fact, these nuances are pure and accordingly more ductile, which gives them less good mechanical resistance in case of a rise in pressure of the casing, and thus fewer good ageing characteristics.

To improve contact resistance between the collector and the electrodes of a supercondenser, the document U.S. Pat. No. 6,565,701 proposes using current collectors comprising a conductive metallic substrate to the surface of which is applied a non-oxidised layer. Electrical conduction between the collectors and the electrodes is thus made easy and their surface ageing is limited.

The document US 2004/0264110 describes an electrical component comprising a current collector, fitted with perforations, and electrodes, in which the electrodes and the collector are separated by an intermediate layer to prevent increase of series resistance of electrodes during operating of the component.

The document DE 32 26 406 also proposes a condenser formed from metallised films, comprising a cover and brazed metallic contact layers on contact parts. A step for depositing metallic particles on the contact parts is necessary before they are welded.

The particular aim of the invention is to eliminate the disadvantages of the prior art.

An aim of the present invention is to propose a production process of the electrical connections of an electrical energy storage unit comprising solid pieces, particularly pieces made of aluminium, by low-temperature diffusion brazing.

Another aim of the present invention is to propose a production process of electrical connections of an electrical energy storage unit decreasing electrical contact resistance between the different current collectors and favouring thermal diffusion and cooling during the internal rise in temperature of the coil.

It is likewise desirable to propose a simple production process of electrical connections of an electrical energy storage unit which offers economy in terms of time in making the units.

Another aim of the present invention is to propose a production process of electrical connections of an electrical energy storage unit for preventing the use of current collectors having bosses or recesses and benefiting homogeneous distribution of the current.

Another aim of the invention is to permit use of nuances of aluminium alloys, other than the purest series, such as the 1000 series. This is permitted by the fact that diffusion brazing does not involve the same limitations as the earlier laser welding process, in terms of choice of alloys, due to the fact of the absence of reactions of inclusions (present in the less pure alloys) in the alloy vis-à-vis the diffusion brazing process.

Another aim of the diffusion brazing is to limit the risk of piercing of the collecting pieces during low-temperature brazing, in comparison to the strong risk of doing this during laser welding, according to the state of the art.

The diffusion brazing process is known to the expert. For example, the document EP 0 123 382 presents a diffusion brazing process of aluminium surfaces covered in a layer of gallium, under high pressure (30 to 100 MPa), over a period of between 70 and 80 hours, whereas the document GB 2 386 578 describes a high-pressure diffusion brazing process (of the order of 20 MPa), at a temperature advantageously above 200° C. of two pieces made of aluminium, after rubbing the contact surfaces with liquid gallium.

Finally, an aim of the present invention is to permit use of a more easily industrialisable process than laser welding, without the safety problems associated with laser technology, and simple and less costly implementation.

### SUMMARY OF THE INVENTION

These aims are attained, according to the invention, by means of a production process of electrical connections between an energy storage coil having current-collecting edges at each of its ends and a current-collecting piece, the association of said pieces forming an electrical energy storage unit placed in a casing, characterised in that the electrical connection of the collecting edges of the coil and the current-collecting pieces is made by a process of low-temperature diffusion brazing, said temperature being less than 400° C.

Advantageously, each current-collecting edge is brazed directly on a current-collecting piece.

The execution temperature is preferably selected between 150 and 400° C. and the process is carried out with contributed metal selected from the group formed by metals with a low melting point comprising gallium, indium, tin, thallium, lead, bismuth, and alloys thereof.

In the event where the support metal is gallium, the processing temperature is selected between 150 and 250° C. In fact, above 218° C., gallium diffuses two ways in aluminium: preponderant intergranular method, between 30 and 110° C. and preponderant volumic (intragranular) method between 110° C. and 218° C. Thus, at a temperature of less than 110° C., there is a not inconsiderable part of intergranular gallium diffusion which is harmful to the content of the material, since this risks embrittling the grain joints. Beyond 218° C., gallium diffusion in the alloy is totally volumic, which presents no further risk either for the material or for the connection.

Preferably, the processing temperature at the level of the brazing zone will be limited to 250° C. so as to limit the temperature undergone by the energy storage coil element in order to avoid degradation of the material which would burden the performance or shelf life of the supercondenser.

According to the invention, the production process of electrical connections of an electrical energy storage unit comprising at least one electrical energy storage coil element intended to be placed inside a casing, said casing having to be closed by at least one cover, said element and said cover each comprising current-collector means, is characterised in that it comprises at least the following steps:
a step of gallium deposit on one or the other of the current-collector means;
an assembly step of the two current-collector means separated by the gallium deposit and,
a diffusion brazing step carried out by application of a force generating in the materials to be assembled a constraint less than 10 Mpa, the unit being brazed over a period of less than 1 h in light of making the electrical connection of the electrical energy storage unit.

### BRIEF DESCRIPTION OF THE FIGURES

The invention will be better understood and other advantages and characteristics will emerge from the following description, given by way of non-limiting example, and in reference to the attached drawings, in which:

FIG. 1 illustrates a production process of electrical connections of an electrical energy storage unit according to the invention;

FIG. 2 illustrates a production process of gallium deposit on a current-collecting piece according to the invention;

FIG. 3 illustrates two form variants of a current-collecting edge of an electrical energy storage unit.

### DETAILED DESCRIPTION OF THE INVENTION

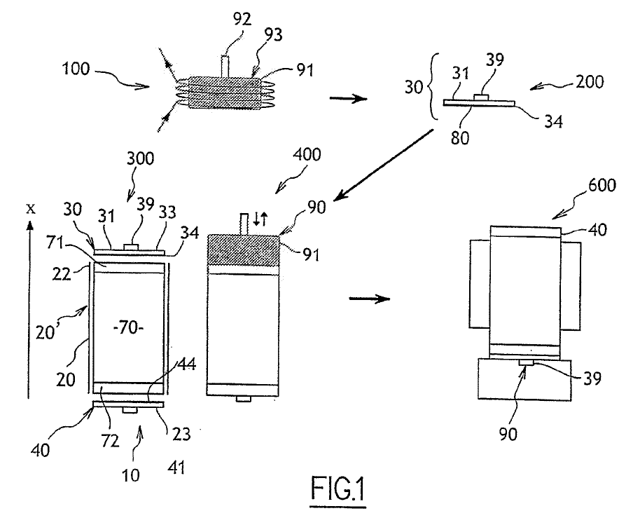

FIG. 1 illustrates a production process of electrical connections of an electrical energy storage unit 10 according to the invention.

An electrical energy storage unit 10 comprises a casing 20″ having a main body 20, enclosing an electrical energy storage coil element 70 placed inside and a unit of two covers 30 and 40 enclosing the main body of the casing 20 at both ends. It likewise comprises on the covers 30 and 40 electrical linking means to said element 70.

In a preferred embodiment of the invention, the electrical and mechanical bond is made between the two covers 30 and 40 and the electrical energy storage element 70 by a low-temperature diffusion brazing process.

It is based on controlled migration of a support metal selected in the group of metals with low melting point, and preferably gallium.

More precisely, an energy storage unit 10 comprises a main body of the casing 20 in the form of a cylinder, open at its two ends 22 and 23 and extending, in the figure, over its length along an axis X.

Advantageously, this cylinder 20 is made of aluminium, supple and conductive.

On the other hand, the latter has an internal diameter and a length adapted to the electrical energy storage element 70 which it houses.

In an embodiment of the invention, the coil element of the electrical energy storage 70 is a cylindrical coil extending in length parallel to the axis X.

This coil is formed, in a manner known per se, from a stack of sheets rolled around a central axis, parallel to the axis X, with or without presence of a central solid support.

The electrical energy storage element 70 is delimited at its two opposites ends, respectively, by two edges 71 and 72 in spiral form forming two extended current collectors of the element 70.

The extended edges 71 and 72 are designed to connect to the electrical linking means of the two covers 30 and 40 which will cover it, as will be described hereinbelow.

Further, the two covers 30 and 40 conductors are each respectively in the form of an electrical connection disc 31 and 41, placed perpendicularly to the axis X.

Advantageously, each of them is rigid and made of aluminium.

The thickness of each of the electrical connection discs 31 and 41 is designed to guarantee, in a manner known per se, a sufficient section for passage of current dependent on the radius of the discs 31 and 41.

On the other hand, the external diameter of each of the electrical connection discs 31 and 41 is equal to the external diameter of the cylinder 20.

Further, as illustrated in FIG. 1, the cover 30 is likewise adapted to comprise an electrical connection stud 39 on its opposite external inner face inside the main body of the casing 20.

It is cylindrical of revolution in shape and placed at the centre of the electrical connection disc 31.

Other variants of electrical connection studs 39 are possible. They are limited to the example illustrated in FIG. 1. Non-limiting examples are female or male screw-in electrical connection studs, rings or even worked tapered studs.

On the other hand, the inner face 34, 44 of the electrical connection disc 31, 41 of each of the covers 30, 40 corresponds to the brazing range utilised as electrical linking means for respectively making the electrical connection between the electrical energy storage element 70 and the covers 30 and 40.

In a preferred embodiment of the invention, the electrical connection of each of the covers 30 and 40 with the two current-collecting edges 71 and 72 of the element 70 is made directly by the following low-temperature diffusion brazing process.

In a first step 100, a mass 93 is brought to a temperature between 300° C./400° C. according to techniques well known per se.

In the variant illustrated in FIG. 1, the heating system corresponds to a ring system heating by induction.

Non-limiting examples are other heating systems such as a convection or conduction oven or, locally, an infrared, UV, Joule effect or ultrasound system.

This heated mass 93 is a metallic billet 91 belonging to a pressure system 92 which will be utilised throughout the process.

In step 200, a fine layer of gallium is deposited on the inner face 34 plate of the cover 30, this inner face representing the current collector of the latter 30.

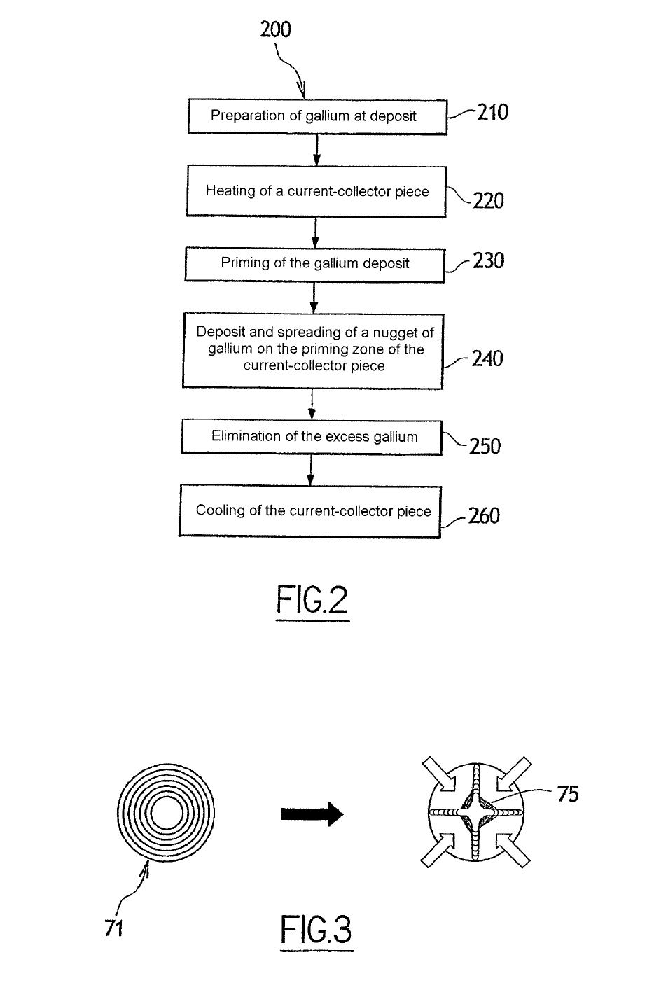

This depositing process will be described hereinbelow in relation to FIG. 2.

A variant embodiment of the process provides the gallium deposit on the current-collecting edges 71 and 72 of the electrical energy storage unit 10.

Then, in step 300, the pieces to be brazed are assembled directly.

The covered cover 30 of the layer of gallium is placed at the end 22 of the cylinder 20, topping the current-collecting edge 71 of the element 70.

In step 400, the higher-temperature billet 91 is deposited on the unit cover 30/current-collecting edge 71 and presses lightly on the unit for a given time.

The brazing time is generally less than 1 hour. The choice of a brazing low-temperature thus preserves the materials of the collecting elements, and to further improve the shelf life of supercondensers, the brazing time has been optimised. Therefore, advantageously, the time for maintaining the billet on the unit of the two pieces 30, 71 to be brazed can be limited to its minimal duration of the order of 30 seconds.

In addition, even pressure of the order of 170 N is typically applied on the unit 30, 71 to ensure optimal contact between the cover 30 and the current-collecting edge 71 of the electrical energy storage element 70 during brazing. This pressure, less than 10 MPa, is adequate for optimising diffusion of the layer of gallium on the collecting edges without as such collapsing it by crushing. We in fact recall that the collecting edges are fine in comparison to the covers, solid.

In contact with the warm mass 93, gallium migrates across the pieces of aluminium 71 and 30 assembled by fully diffusing in the grains of aluminium. It leaves the inner face of the pieces 30, 71 to be replaced by atoms of aluminium, thus creating close contact between the latter two 71 and 30.

This diffusion brazing step is characterised by a time/temperature control couple. The parameters of the diffusion brazing process, such as temperature, time, pressure, etc. must in fact belong to a defined range of values if the integrity of the current-collecting edges are to be preserved throughout the process, the latter being directly brazed on the cover.

Brazing is completed advantageously at a temperature over 210° C., preferably 220° C. (temperature of the warm mass 91), the maintenance time diminishing with the increase in temperature of the latter.

In fact, under this temperature threshold, gallium can cause embrittlement by cracking as it enters the joints of grains of the aluminium.

In the following step, the billet 91 is withdrawn from the electrical energy storage unit 10 and is then cooled in step 600 to avoid internal reheating of the electrical energy storage element 70 by conduction in the current collectors 71 and 30 made of aluminium.

Cooling is preferably done either by topping the cover 30 by a cooling system, or in open air.

In a variant embodiment of the invention, cooling is carried out continuously throughout the process by enclosing the electrical energy storage unit 10 by a cooling system.

To make electrical connection of the energy storage element 70 with the second cover 40, the steps are renewed similarly.

The result is an energy storage unit 10 whereof the electrical connection is made by a low-temperature gallium diffusion brazing process.

A variant embodiment of a process according to the invention provides current-collecting pieces other than the covers 30 and 40 such as the electrical connection studs themselves or any other piece well known per se.

Another variant embodiment of a process according to the invention proposes using covers having bosses or grooves as brazing ranges.

The process for depositing a fine layer of gallium of step 200 will now be described in reference to FIG. 2.

The gallium is deposited according to a particular procedure which prevents intergranular diffusion of gallium in the aluminium, a phenomenon which can commence from the depositing phase.

The process comprises the following steps.

In step 210, gallium or an alloy thereof is prepared for deposit. It is divided into small nuggets of a few milligrams to reduce the risk of embrittlement during brazing.

In step 220, one of the two current-collecting pieces 71 or 30 which will be assembled is brought to a temperature above 30° C.

Advantageously, it has risen in temperature to a temperature of the order of 40° C. to 50° C.

The following step 230 corresponds to a priming step 230 of the gallium deposit.

In fact, the inventors noted that to allow spreading of the necessary quantity of gallium to ensure brazing on the surface of the pieces to be brazed, it was necessary to make an initial deposit of a very small quantity of solid gallium on the surface to be brazed of one of the current-collecting pieces 71 and 30, gallium which is then spread and whereof the excess is drawn off by way of appropriate spreading means.

This initial deposit can be done by any means: mechanical deposit of liquid or solid gallium, electrochemical deposit, chemical deposit in vapour phase (CVD), deposit by centrifuging (spin coating), pulverisation of metallic particles (metal spraying), deposit by soaking, deposit by cathodic pulverisation, nanoparticle jet, electronic bombardment, plasma evaporation, thermal evaporation, cathodic arc, anodic or laser evaporation, interposition of a metal layer containing gallium.

This initial deposit of a small quantity of gallium ensures wettability of the pieces to be brazed, to then allow the quantity of gallium necessary for brazing to diffuse on the surface of the pieces to be brazed.

The inventors have also noted that simple passing of a brush previously contaminated by gallium resulting for example from cleaning a previous piece over the surface of the pieces was sufficient to ensure wettability of said pieces and to form the priming zone of the depositing to follow.

This priming step 230 is then followed by a step 240 for deposit of a nugget of gallium on the priming zone to be spread with the brush on the surface to be brazed 71, 30.

The excess gallium is then recovered by any appropriate means (step 250).

The deposit is preferably rubbed with the brush.

Spatulas which would risk creating cracks on the surfaces to be brazed and cause intergranular gallium diffusion in the aluminium are to be avoided.

The pieces 30 and 71, respectively 40 and 72 are then put in contact and pressed against one another to ensure their adhesion by diffusion brazing.

Finally, in a final step 260, the current-collecting piece 71, 30 where gallium has been deposited is cooled by appropriate means to solidify gallium as fast as possible and to block any diffusion mechanism.

Cooling systems such as open air or a refrigerator are adapted means.

Advantageously, during this process 200 of gallium depositing a quantity of gallium of the order of 0.4 to 1 mg/cm² is deposited.

A quantity of gallium of 0.5 mg/cm² is preferably deposited.

In a variant embodiment of this process illustrated in FIG. 3, deformation of the projecting current collector of the energy storage element 70 and more precisely of the current-collecting edges 71 and 72 occurs.

These edges 71 and 72 are deformed by leading the turns of the electrical energy storage element 70 radially towards the centre of the edge to form a four-pointed star 75.

This configuration reinforces the support zones with the second current-collecting piece 30 during the gallium diffusion brazing process.

Another variant embodiment of the process comprises a levelling step of the current-collecting edges 71 and 72 parallel to each of the internal faces 34, 44 of the covers 30 and 40 of the unit 10 to increase the contact surface between these two current-collecting pieces and, consequently, their brazing surface.

Another variant embodiment of the process comprises an aggregating step of aluminium balls projected on the current-collecting edges 71 and 72 (metal spraying) with a certain angle to create reinforced support zones with the second current-collecting piece 30 during the gallium diffusion brazing process.

In all these variants, the other steps of the process according to the invention remain identical to those described previously in relation to FIGS. 1 and 2.

The expert will appreciate a rapid low-temperature production process of electrical connections of an electrical energy storage unit 10, which is simple and reliable in proposing precise and efficacious electrical connection.

On the other hand, relative to processes known from the state of the art, this process makes electrical energy storage units 10 having homogeneous distribution of the current in the electrical energy storage element 70, efficacious thermal diffusion and limited electrical contact resistance between current-collecting pieces.

Finally, the present invention is not limited to supercondensers and can be executed for any high-energy electrical energy storage unit. Non-limiting examples are generators, batteries or condensers.

Of course, the present invention is not limited to the particular embodiments which have just been described, but extends to any variant in keeping with its spirit. In particular, the present invention is not limited to the attached drawings. The specific references illustrated in the preceding paragraphs are non-limiting examples of the invention. Similarly, the example shown here relates to diffusion brazing of a cover, utilised directly as current-collecting piece, on the collecting edges of the coil. It is evident that the principle applies in the same way between the collecting edges of the coil and an intermediate connection piece between the coil and the cover, if this type of architecture was chosen.

1. A production process of electrical connections between an energy storage coil (70) having current-collecting edges (71, 72) at each of its ends and a current-collecting piece (30, 40), the association of said pieces forming an electrical energy storage unit (10) placed in a casing (20), characterised in that the electrical connecting of the collecting edges (71, 72) of the coil (70) and the current-collecting pieces (30, 40) is completed by a process of low-temperature diffusion brazing, said temperature being less than 400° C.

2. The process as claimed in claim 1, characterised in that each current-collecting edge (30, 40) is brazed directly on a current-collecting piece (30, 40).

3. The process as claimed in any one of claims 1 or 2, characterised in that the working temperature is selected between 150 and 400° C.

4. The process as claimed in any one of claims 1 to 3, characterised in that the diffusion brazing is completed with a contributed metal selected in the group formed from metals with a low melting point comprising cadmium, gallium, indium, tin, thallium, lead, bismuth, and zinc, and alloys thereof.

5. The process as claimed in claim 4, characterised in that the contributed metal is gallium, or a compound containing gallium.

6. The process as claimed in any one of claims 1 to 5, characterised in that the brazing temperature at the interface between the pieces to be assembled is selected between 150 and 250° C.

7. The production process as claimed in any one of the preceding claims, of electrical connections of an electrical energy storage unit (10) comprising at least one electrical energy storage coil element (70) intended to be placed inside a casing (20″), said casing (20″) having to be closed by at least one cover (30, 40), said element (70) and said cover (30, 40) each comprising current-collector means (71, 72, 34, 44), the process being characterised in that it comprises at least the following steps:
a step (200) of contributed gallium on one or the other of the current-collector means (71, 72, 34, 44);
an assembly step (300) of the two current-collector means (71, 72, 34, 44) separated by the gallium deposit and,
a diffusion brazing step (400) completed by application of a force generating in the materials to be assembled a restriction less than or equal to 10 Mpa, the unit being brazed over a period of less than 1 h, in light of making an electrical connection of the electrical energy storage unit.

8. The production process as claimed in any one of the preceding claims, of electrical connections of an electrical energy storage unit (10), characterised in that contributed gallium at the interface between the current-collector means is completed by one, or the combination of several, of the following methods: mechanical deposit of liquid or solid gallium, electrochemical deposit, chemical deposit in vapour phase (CVD), deposit by centrifuging (spin coating), pulverisation of metallic particles (metal spraying), deposit by soaking, deposit by cathodic pulverisation, nanoparticle jet, electronic bombardment, plasma evaporation, thermal evaporation, cathodic arc, anodic or laser evaporation, interposition of a metal layer containing gallium.

9. The process as claimed in any one of the preceding claims, characterised in that a step (200) of gallium deposit comprises at least the following substeps:
a heating step (220) of one of the current-collector means (71, 72, 34, 44)
a priming step (230) of the gallium deposit;
a step (240) of depositing and spreading a nugget of gallium on the priming zone of said current-collector means (71, 72, 34, 44) heated to a given temperature;
a cooling stage of said current-collector means (71, 72, 34, 44).

10. The process as claimed in the preceding claim, characterised in that heating one of the current-collector means is done by one of the heating means from the following group: heating by induction, by radiation, by convection, by conduction, by Joule effect, by infrared or by ultrasound.

11. The process as claimed in any one of claims 8 to 10, characterised in that it also comprises a step (250) of elimination of the excess gallium before cooling of the current-collector means.

12. The process as claimed in any one of claims 8 to 11, characterised in that the priming step (20) is completed by contaminating one of the current-collector means (71, 72, 34, 44) with a low dose of gallium powder.

13. The process as claimed in any one of the preceding claims, characterised in that the current-collector means (71, 72, 34, 44) are made of aluminium or light alloy.

14. The process as claimed in any one of the preceding claims, characterised in that it also comprises a cooling stage of the electrical energy storage unit (10) during the diffusion brazing step with the exception of the part during brazing.

15. The process as claimed in any one of the preceding claims, characterised in that the quantity of gallium deposited is less than 1 mg/cm².

16. The process as claimed in any one of the preceding claims, characterised in that the quantity of gallium deposited is between 0.4 and 0.6 mg/cm².

17. The process as claimed in any one of the preceding claims, characterised in that the current-collector means of the cover (30, 40) correspond to the inner face (34, 44) of the latter.

18. The process as claimed in any one of the preceding claims characterised in that the current-collector means (71, 72) of the electrical energy storage coil element (70) are a current-collecting edge (71, 72) in the form of a spiral of the latter.

19. The process as claimed in the preceding claim, characterised in that it also comprises a deformation step of the current-collecting edge (71, 72) of the electrical energy storage coil element (70) in a star form.

20. The process as claimed in any one of the preceding claims, characterised in that it also comprises a levelling step of the current-collecting edge (71, 72) of the electrical energy storage coil element (70) parallel to the inner face (34, 44) of the cover (30, 40).

21. The process as claimed in claim 19, characterised in that it also comprises prior to the diffusion brazing step an agglomeration step (metal spraying) of aluminium balls projected on the current-collecting edge (71, 72) of the electrical energy storage element (70) with a certain angle so as to create support zones reinforced with the second current-collector means (34, 44).

22. An electrical energy storage unit made by a process as claimed in any one of the preceding claims 1 to 21.
